(19) United States
(12) Patent Application Publication
(10) Pub. No.: US 2012/0105794 A1
(43) Pub. Date: May 3, 2012

(54) LIQUID CRYSTAL EJECTOR, EJECTION DEVICE, AND LIQUID CRYSTAL EJECTION METHOD

(75) Inventors: Chengming He, Shenzhen (CN); Yu-wu Huang, Shenzhen (CN)

(73) Assignee: CHENZHEN CHINA STAR OPTOELECTRONICS TECHNOLOGY CO., LTD., Shenzhen (CN)

(21) Appl. No.: 13/216,753

(22) Filed: Aug. 24, 2011

(30) Foreign Application Priority Data
Nov. 1, 2010 (CN) 201010527432.X

(51) Int. Cl. G02F 1/1341

(52) U.S. Cl. 349/189

(57) ABSTRACT

The present invention relates to a liquid crystal ejector, an ejection device, and a liquid crystal ejection method. The liquid crystal ejector includes a liquid crystal container, a nozzle, and a driver. A liquid crystal contained in the liquid crystal container is ejected through the nozzle. The driver controls an amount of the liquid crystal ejected from the liquid crystal container. The driver includes an electrical resonator, which pressurizes the liquid crystal contained in the liquid crystal container according an input of electrical signal in order to realize control of the ejection amount of liquid crystal. The present invention also provides an ejection device and a liquid crystal ejection method. An advantage of the present invention is using a liquid crystal ejector that uses an electrical resonator to control the size of ejected droplets so as to eliminate the occurrence of voids in the process of spreading and avoid marking occurring in the surface of a film due to impact-induced damage.

### BACKGROUND OF THE INVENTION

1. Field of the Invention

The present invention generally relates to the field of manufacture of liquid crystal displays, and in particular to a liquid crystal ejector, an ejection device, and a liquid crystal ejection method.

2. The Related Arts

In the state of the art, ODF (One Drop Filling) technology is often adopted for filling liquid crystal into a pane. The technology is performed by first applying a UV-cured seal with an applicator and then uniformly dripping a liquid crystal substance on a surface of a lower glass substrate. Afterwards, the lower glass substrate is placed in a vacuum environment for proceeding with the operations of aligning an upper glass substrate, pasting, and curving to complete packaging of a cell of the liquid crystal panel.

When the liquid crystal dripping device drops liquid crystal droplets down to a panel, the liquid crystal dripping device distributes a plurality of droplets of liquid crystal on a surface of a film according to a predetermined pattern so that the liquid crystal droplets are spaced by a constant distance. FIG. 1A shows a schematic view of a state-of-the-art dripping device, illustrating the condition when the liquid crystal droplets drop onto the film surface, wherein a film 10, a sealing frame 11 formed on a surface of the film 10, and a plurality of dripping units 12 are included. The dripping units 12 form a plurality of liquid crystal droplets 13 that is arranged in an array on the surface of the film 10. The liquid crystal droplets 13 gradually spread to combine with each other with time elapsing. The state-of-the-art dripping unit 12 adopts natural dropping process, wherein liquid crystal is driven by the gravity thereof to naturally drop from the dripping unit 12.

The liquid crystal droplet generated through the naturally dropping process is of a large size. Thus, if the time when the liquid crystal droplet 13 is allowed to spread out is insufficient in the process of operation, the insufficient spreading of the liquid crystal might cause areas that are not covered by liquid crystal between adjacent liquid crystal droplets, whereby a continuous liquid crystal film that is later formed by the combination of the droplets may contain void defects existing therein. FIG. 1B is a schematic view showing voids 14 generated between the liquid crystal droplets 13 when the above described situation occurs. In the currently adopted liquid crystal dripping process, the time interval that is allowed between the operation of liquid crystal dripping and the operation of inspection with a light-on tester is getting shorter and shorter, making it not possible for the liquid crystal to sufficiently spread out, so that voids are found in the liquid crystal by the light-on tester. Although lapse of time may result in complete spread of the liquid crystal and voids may disappear, yet what described above will certainly lead to incorrect identification of defect liquid crystal dripping by the light-on tester, and such a situation may cause unnecessary re-working.

Further, in case that the liquid crystal droplet 13 is ejected with an excessive mass (being greater than 0.3 mg), a tiny damage marking of contour deviation, which is something like a “concavity”, may be formed in a surface of an alignment film (polyimide (PI) film) of the film 10, and this consequently causes a Mura defect of liquid crystal droplet. An edge Mura defect is the occurrence of wavy pattern observed by the light-on tester due to the situation that a periphery of a panel is higher than an internal area of the panel. Thus, in the state of the art, a sufficient time is required for the spreading of liquid crystal and the time interval between liquid crystal dripping and the curing of the sealing frame by ultraviolet light is severely related to the location where a liquid crystal droplet drops and the location where the liquid crystal droplet is distant from the sealing frame. Consequently, edge Mura may result if the adjustment is not set properly.

### SUMMARY OF THE INVENTION

To overcome the various technical problems discussed above, the present invention provides a liquid crystal ejector, an ejection device, and a liquid crystal ejection method, in order to reduce the size of a liquid crystal droplet, eliminate the occurrence of voids in the surface of a film, and avoid the occurrence of marking caused by impact induced damage on the surface of a film.

To solve the above problems, the present invention provides a liquid crystal ejector, which comprises a liquid crystal container, a nozzle, and a driver. The nozzle is arranged at a bottom of the liquid crystal container. A liquid crystal contained in the liquid crystal container is ejected through the nozzle. The driver controls an amount of the liquid crystal ejected from the liquid crystal container. The driver comprises an electrical resonator, which generates resonance according an input of electrical signal to pressurize the liquid crystal contained in the liquid crystal container in order to realize control of the ejection amount of liquid crystal.

As a feasible technical solution, the electrical resonator comprises a piezoelectric ceramic and two electrodes electrically connected to the piezoelectric ceramic. The piezoelectric ceramic is set in tight engagement with the liquid crystal contained in the liquid crystal container. The piezoelectric ceramic generates vibration with an alternate current flowing therethrough so as to apply a pressure in the liquid crystal contained in the liquid crystal container.

As a feasible technical solution, the electrical resonator comprises an electromagnetic coil and a metal plate. The electromagnetic coil, when subjected to variation of an electrical signal applied thereto, induces variation of a surrounding magnetic field that causes vibration of the metal plate.

As a feasible technical solution, a load voltage applied to the electrical resonator is adjusted according to viscosity of the liquid crystal in order to realize ejection of a desired amount of liquid crystal from the liquid crystal ejector.

The present invention also provides an ejection device, which comprises a liquid crystal ejector positioned above a film. The film has a surface on which a plurality of sealing frames is formed. The liquid crystal ejector is movable in a direction parallel to the film to eject a liquid crystal into spaces enclosed by the sealing frames. The liquid crystal ejector comprises a liquid crystal container, a nozzle, and a driver. The nozzle is arranged at a bottom of the liquid crystal container. A liquid crystal contained in the liquid crystal container is ejected through the nozzle. The driver controls an amount of the liquid crystal ejected from the liquid crystal container. The driver comprises an electrical resonator, which generates resonance according an input of electrical signal to pressurize the liquid crystal contained in the liquid crystal container in order to realize control of the ejection amount of liquid crystal.

The present invention further provides a liquid crystal ejection method, which comprises positioning a liquid crystal ejector above a surface of a film; applying a driving voltage to an electrical resonator of the liquid crystal ejector according to a desired size of liquid crystal droplet; and displacing the liquid crystal ejector in a direction parallel to the film to form uniform distribution of liquid crystal droplets on the film.

An advantage of the present invention is using a liquid crystal ejector that uses an electrical resonator to control the size of ejected droplets. Since the liquid crystal droplets so formed are of a tiny size, the time period required for spreading is relatively short and the occurrence of voids in the spreading process can be eliminated. The small size of the liquid crystal droplets helps preventing the occurrence of marking in the surface of a film caused by impact-induced damage.

### BRIEF DESCRIPTION OF THE DRAWINGS

FIG. 1A is a schematic view showing a state-of-the-art dripping device.

FIG. 1B is a schematic view showing voids generated in a liquid crystal film after droplets are made the state-of-the-art dripping device.

FIG. 2 is a schematic view showing a liquid crystal ejector according to an embodiment of the present invention.

FIG. 3 is a schematic view demonstrating the steps of a liquid crystal dripping method according to an embodiment of the present invention.

### DETAILED DESCRIPTION OF PREFERRED EMBODIMENT AND THE BEST MODE FOR CARRYING OUT THE PRESENT INVENTION

A detailed description of embodiments of the present invention in association with a liquid crystal ejector, an ejection device, and a liquid crystal ejection method will be given with reference to the attached drawings.

For better and easy understanding of the objectives, features, and advantages of the present invention, preferred embodiments of the present invention will be illustrated in details with reference to the drawings attached herein. Various embodiments of the present invention will be illustrated hereinafter to show the technical features of various ways of embodying the present invention. In the following description, it is noted that the arrangements of components/parts in the illustrated embodiments are simply for illustration of the inventive contents disclosed herein, rather than to limit the scope of the present invention. Further, reference numerals used in various embodiments may be repeated and this is for the purpose of simplifying the description and is not to infer any specific correlation between different embodiments.

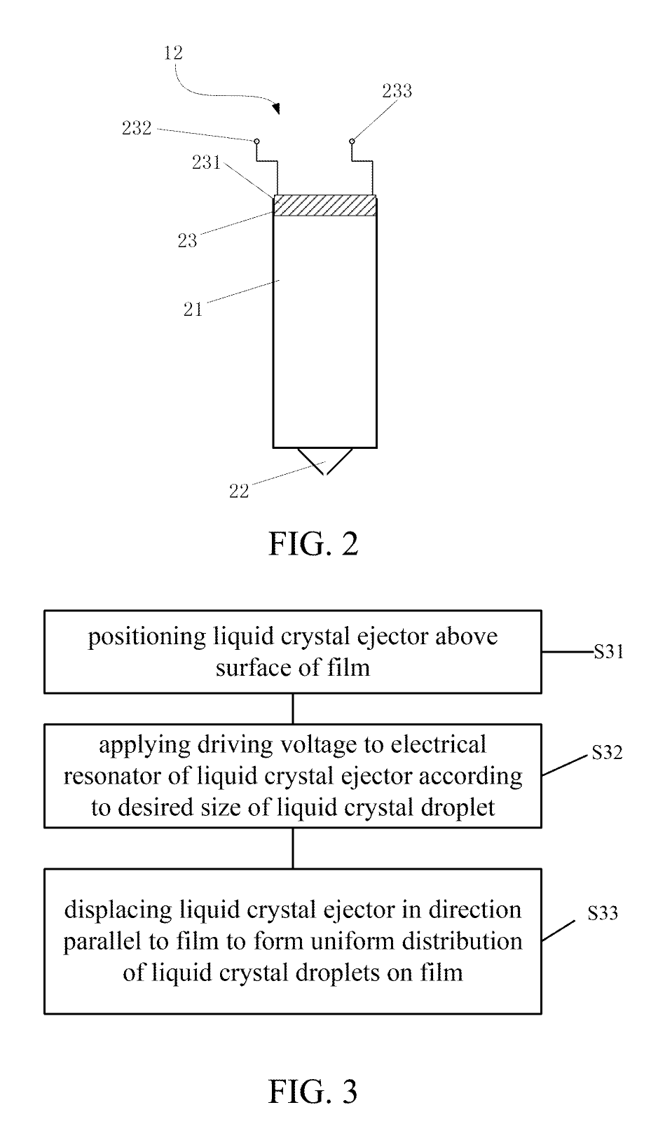

FIG. 2 is a schematic view showing a liquid crystal ejector according to an embodiment of the present invention.

Referring to FIG. 2, the liquid crystal ejector 12 comprises a liquid crystal container 21, a nozzle 22, and an electrical resonator 23. The electrical resonator 23 is a driver for driving an ejection operation of the liquid crystal ejector. The nozzle 22 is arranged at a bottom of the liquid crystal container 21. Liquid crystal contained in the liquid crystal container 21 is ejected through the nozzle 22. The electrical resonator 23 controls an amount of liquid crystal ejected from the liquid crystal container 21. The liquid crystal container 21 further comprises a liquid crystal inlet opening (not shown) for replenishment of liquid crystal.

In the instant embodiment, the electrical resonator 23 is an electrically-controlled pressurization device and, specifically speaking, comprises a piezoelectric ceramic 231 and two electrodes 232, 233 electrically connected to the piezoelectric ceramic 231. The piezoelectric ceramic is characterized by being deformable by conduction of an electrical current therethrough and the size of deformation is related to the magnitude of the electrical current flowing therethrough. The greater the electrical current is, the larger the deformation will be induced. Thus, the piezoelectric ceramic 231 may pressurize the liquid crystal contained in the liquid crystal container 21 according to an input of electrical signal in order to control the amount of liquid crystal ejected from the nozzle 22. Liquid crystal is ejected from the nozzle 22 in the form of droplets, and obviously, the greater the pressure that the liquid crystal is subjected to, the greater the volume of the liquid crystal droplet ejected from the nozzle 22.

The piezoelectric ceramic 231 are set in tight engagement with the liquid crystal contained in the liquid crystal container 21. As mentioned previously, under the condition that electrical currents flow through the piezoelectric ceramic 231, deformations are induced in the piezoelectric ceramic by the various electrical currents, whereby through application of a regularly varied electrical current through the piezoelectric ceramic 231, the piezoelectric ceramic 231 induces regularly varied deformation, namely generating vibration, in order to apply a pressure in the liquid crystal contained in the liquid crystal container 21.

In other embodiments, the piezoelectric ceramic 231 shown in FIG. 2 can be replaced by other electrically-controlled pressurization devices, such as an electromagnetic coil and a metal plate. The metal plate is arranged at one end of the electromagnetic coil and is set in tight engagement with the liquid crystal. The electromagnetic coil, when subjected to variation of an electrical signal applied thereto, induces variation of a surrounding magnetic field that causes vibration of the metal plate, which in turn induces pressurization of the liquid crystal.

FIG. 3 is a schematic view demonstrating the steps of a liquid crystal dripping method according to an embodiment. A liquid crystal ejection method carried out with the liquid crystal ejector described above comprises the following steps: Step S31, positioning the liquid crystal ejector above a surface of a film; Step S32, applying a driving voltage to the electrical resonator of the liquid crystal ejector according to a desired size of liquid crystal droplet; and Step S33, displacing the liquid crystal ejector in a direction parallel to the film to thereby form uniform distribution of liquid crystal on the film.

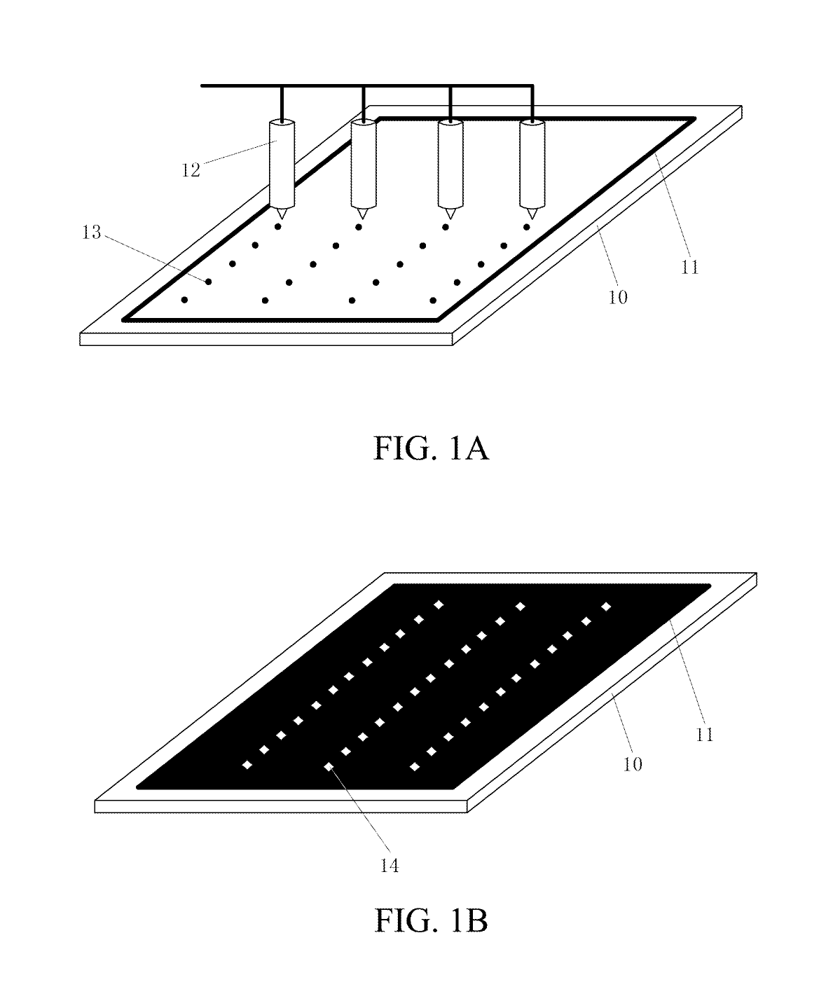

Step S31 is to position the liquid crystal ejector above the surface of the film. In this step, a relative position between the liquid crystal ejector and the film is set as shown in FIG. 1.

Step S32 is to apply a driving voltage to the electrical resonator of the liquid crystal ejector according to a desired size of liquid crystal droplet. Taking the piezoelectric ceramic shown in FIG. 2 as an example of the electrical resonator, in this step, the load voltage of the electrical resonator and the ejected amount of liquid crystal are substantially proportional in the trends thereof. To obtain a larger size of liquid crystal droplet, a greater signal of electric voltage must be applied to the piezoelectric ceramic; on the other hand, to control the size of liquid crystal droplet to be smaller, the applied voltage must be lowered. Experiments revealed that for a liquid crystal ejector that uses a piezoelectric ceramic as an electrically-controlled pressurization device, the mass of liquid crystal droplet can be controlled to be approximately 6×10⁻⁸ mg, which is much less than 0.3 mg found in the naturally dripping method.

In this step, if the amount of ejection from the liquid crystal ejector needs to be more precisely controlled, the level of load voltage applied to the electrical resonator may be further adjusted according to the viscosity of the liquid crystal used in order to realize ejection of a desired amount of liquid crystal from the liquid crystal ejector. The viscosity of liquid crystal is around 20-30 centipoises (CP), and the viscosity of polyimide (PI) is around 2-5CP. In other words, liquid crystal has a high viscosity and applying an electrical voltage to deform the space associated with “piezoelectric ceramic” for ejection of liquid crystal may often cause “time delay” or insufficient amount of ejection due to the high viscosity of liquid crystal. Adjustment may be made on the electrical voltage according to the different viscosities of liquid crystals in order to achieve the desired amount of liquid crystal. For example, if the application of 1V voltage may achieve the ejection of 1 mg, then in the embodiment, it only results in an actual amount of ejection of 0.8 mg. Thus, it would be possible in the manufacturing process to apply a 1.2V voltage to achieve the desired ejection amount of 1 mg. This example is only for explanation and understanding of the present invention and is not to limit the scope of the invention. Further, the smaller the size of a liquid droplet is, the greater the corresponding frequency of ejection must be in order to ensure sufficiently dense arrangement of liquid crystal droplets, where the distance between the liquid crystal droplets is sufficiently small to ensure proper spread for the formation of a continuous film.

Step S33 is to displace the liquid crystal ejector in a direction parallel to the film to thereby form uniform distribution of liquid crystal on the film.

After the formation of the liquid crystal droplets, a time period is taken for standing still to allow the liquid crystal droplets on the surface of the film to be acted upon by surface tension to combine with each other to form a layer of continuous liquid crystal film. Since in the instant embodiment, the liquid crystal ejector forms liquid crystal droplets of a tiny size, the time period required for spreading is relatively short and the occurrence of voids in the spreading process can be eliminated. The ejection method according to the present invention is very much like a process of dripping liquid crystal to immediately form a film, so that the distance between two adjacent ejected spots is small and immediate spreading for film formation proceeds with the progress of the operation and there is almost no need to preserve a specific time period for spreading. Consequently, it is no longer possible for the light-on tester to find a fault void.

Further, the small size of liquid crystal droplet helps preventing the occurrence of marking in the surface of a film caused by impact-induced damage. The ejection method according to the instant embodiment realizes small ejection spot and uniform spread, so that there is no need to specifically control the time period from dripping of liquid crystal dripping to curing of sealing frame by ultraviolet light and it is not easy for edge Mura problem to occur.

The above description is made simply for certain preferred embodiments of the present invention and it is noted that for those having ordinary skills of this technical field, various modifications and variations may be made without departing from the principle of the present invention. These modifications and variations are considered within the scope of protection of the present invention.

What is claimed is:

1. An ejection device, characterized by comprising a liquid crystal ejector positioned above a film, the film having a surface on which a plurality of sealing frames is formed, the liquid crystal ejector being movable in a direction parallel to the film to eject a liquid crystal into spaces enclosed by the sealing frames; the liquid crystal ejector comprising a liquid crystal container, a nozzle, and a driver, the nozzle being arranged at a bottom of the liquid crystal container, a liquid crystal contained in the liquid crystal container being ejected through the nozzle, the driver controlling an amount of the liquid crystal ejected from the liquid crystal container, the driver comprising an electrical resonator, which generates resonance according an input of electrical signal to pressurize the liquid crystal contained in the liquid crystal container in order to realize control of the ejection amount of liquid crystal.

2. The ejection device as claimed in claim 1, characterized in that the electrical resonator comprises a piezoelectric ceramic and two electrodes electrically connected to the piezoelectric ceramic, the piezoelectric ceramic being set in tight engagement with the liquid crystal contained in the liquid crystal container, the piezoelectric ceramic generating vibration with an alternate current flowing therethrough so as to apply a pressure in the liquid crystal contained in the liquid crystal container.

3. The ejection device as claimed in claim 1, characterized in that the electrical resonator comprises an electromagnetic coil and a metal plate, and the electromagnetic coil, when subjected to variation of an electrical signal applied thereto, induces variation of a surrounding magnetic field that causes vibration of the metal plate.

4. The ejection device as claimed in claim 1, characterized in that a load voltage applied to the electrical resonator is adjusted according to viscosity of the liquid crystal in order to realize ejection of a desired amount of liquid crystal from the liquid crystal ejector.

5. The ejection device as claimed in claim 1, characterized in that the liquid crystal container further comprises a liquid crystal inlet opening for replenishment of the liquid crystal.

6. The ejection device as claimed in claim 1, characterized in that load voltage of the electrical resonator and the ejected amount of liquid crystal are substantially proportional in the trends thereof.

7. A liquid crystal ejector, characterized by comprising a liquid crystal container, a nozzle, and a driver, the nozzle being arranged at a bottom of the liquid crystal container, a liquid crystal contained in the liquid crystal container being ejected through the nozzle, the driver controlling an amount of the liquid crystal ejected from the liquid crystal container, the driver comprising an electrical resonator, which generates resonance according an input of electrical signal to pressurize the liquid crystal contained in the liquid crystal container in order to realize control of the ejection amount of liquid crystal.

8. The liquid crystal ejector as claimed in claim 7, characterized in that the electrical resonator comprises a piezoelectric ceramic and two electrodes electrically connected to the piezoelectric ceramic, the piezoelectric ceramic being set in tight engagement with the liquid crystal contained in the liquid crystal container, the piezoelectric ceramic generating vibration with an alternate current flowing therethrough so as to apply a pressure in the liquid crystal contained in the liquid crystal container.

9. The liquid crystal ejector as claimed in claim 7, characterized in that the electrical resonator comprises an electromagnetic coil and a metal plate, and the electromagnetic coil, when subjected to variation of an electrical signal applied thereto, induces variation of a surrounding magnetic field that causes vibration of the metal plate.

10. The liquid crystal ejector as claimed in claim 7, characterized in that a load voltage applied to the electrical resonator is adjusted according to viscosity of the liquid crystal in order to realize ejection of a desired amount of liquid crystal from the liquid crystal ejector.

11. The liquid crystal ejector as claimed in claim 7, characterized in that the liquid crystal container further comprises a liquid crystal inlet opening for replenishment of the liquid crystal.

12. The liquid crystal ejector as claimed in claim 7, characterized in that load voltage of the electrical resonator and the ejected amount of liquid crystal are substantially proportional in the trends thereof.

13. A liquid crystal ejection method, characterized by comprising:
positioning a liquid crystal ejector above a surface of a film;
applying a driving voltage to an electrical resonator of the liquid crystal ejector according to a desired size of liquid crystal droplet; and
displacing the liquid crystal ejector in a direction parallel to the film to form uniform distribution of liquid crystal droplets on the film.

14. The liquid crystal ejection method as claimed in claim 13, characterized in that the step of applying a driving voltage to an electrical resonator further comprises adjusting load voltage applied to the electrical resonator according to viscosity of the liquid crystal in order to realize ejection of a desired amount of liquid crystal from the liquid crystal ejector.

15. The liquid crystal ejection method as claimed in claim 13, characterized in that load voltage of the electrical resonator and the ejected amount of liquid crystal are substantially proportional in the trends thereof.
